(19) United States
(12) Patent Application Publication
(10) Pub. No.: US 2010/0138934 A1
(43) Pub. Date: Jun. 3, 2010

(54) INFORMATION PROCESSOR

(75) Inventor: Hiroyuki Minoshima, Tokyo (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/628,486

(22) Filed: Dec. 1, 2009

(30) Foreign Application Priority Data
Dec. 3, 2008 (JP) 2008-308239

(51) Int. Cl. G06F 12/14

(52) U.S. Cl. 726/30

(57) ABSTRACT

An information processor for controlling a storage device for storing content information, includes: a controller for receiving content information from the exterior and storing the content information in the storage device; and a generator for generating unique information that is unique to combination of the content information and the information processor through an operation of identification information of the content information and the information processor; wherein when the controller receives content information, the controller checks whether the content information includes information matching with the unique information and upon confirmation of both the information allows the content information to be stored in the storage device.

### CROSS-REFERENCE TO RELATED APPLICATIONS

This application is based upon and claims the benefit of priority of the prior Japanese Patent Application No. 2008-308239 filed on Dec 3, 2008, the entire contents of which are incorporated herein by reference.

### FIELD

The embodiments discussed herein are related to a technique for recording and playing back contents to which content protection regulations are applied.

### BACKGROUND

As the management of copyrights on contents (digital contents) such as video and music has been enhanced, techniques for appropriately protecting the rights of copyright holders while considering convenience for users have been provided. For example, a technique for encrypting a content to be protected when copying the content from a storage device to a medium exists. According to this technique, the use of contents in equipment that does not support the technique can be prohibited.

Moreover, a technique for storing the number of times each content can be used in a storage device as management information and permitting using the content predetermined times exists. Moreover, in view of possible falsification of management information, a technique for preventing falsification of management information by generating the hash value of management information and storing the hash value in a nonvolatile memory exists (for example, refer to Japanese Laid-open Patent Publication No. 2000-306328 or Japanese Laid-open Patent Publication No. 2001-075868 described below).

Moreover, a technique for encrypting a content on the side of a storage device and transferring the encryption key to a mobile terminal when transferring the content from the storage device to the mobile terminal exists (for example, refer to Japanese Laid-open Patent Publication No. 2005-332092 described below). According to this technique, only when a mobile terminal is connected to a storage device, an operation of decrypting contents on the side of the storage device is permitted.

### SUMMARY

According to an aspect of the embodiment, an information processor for controlling a storage device, for storing content information, includes: a controller for receiving content information from the exterior and storing the content information in the storage device; and a generator for generating unique information that is unique to combination of the content information and the information processor through an operation of identification information of the content information and the information processor; wherein when the controller receives content information, the controller checks whether the content information includes information matching with the unique information and upon confirmation of both the information allows the content information to be stored in the storage device.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1D are the outlines of the present technique;

FIG. 2 is a block diagram illustrating exemplary hardware components of a recording and playback device according to a first embodiment;

FIG. 3 is an example of the storage content of a content information table;

FIG. 4 is a block diagram illustrating the functional components of the recording and playback device according to the first embodiment;

FIGS. 5A and 5B are determination result tables;

FIGS. 6A to 6C are determination result tables;

FIG. 7 is a flowchart illustrating an example of the content protection procedure of the recording and playback device according to the first embodiment;

FIG. 8 is a block diagram of exemplary hardware components of a recording and playback device according to a second embodiment;

FIG. 9 is an example of the storage content of a content information table;

FIG. 10 is a block diagram illustrating the functional components of the recording and playback device according to the second embodiment;

FIG. 11 is a flowchart illustrating an example of the content protection procedure of the recording and playback device according to the second embodiment;

FIG. 12 is a flowchart illustrating an example of the procedure for creating a content information table; and

FIGS. 13A to 13E are exemplary operations in the management of copyrights on contents.

### DESCRIPTION OF EMBODIMENTS

In the aforementioned known techniques, it is difficult to securely associate, in a one-to-one manner, storage devices with media to which contents are copied from the storage devices. Thus, a problem exists in that it is difficult to implement an operation of permitting only the use of a content in a medium in a storage device used to record the content.

According to the known technique disclosed in Patent Document 3 described above, the aforementioned operation may be implemented by adopting an application in which the use by a mobile terminal is limited to be available only when the mobile terminal is connected to a storage device. However, in general, when a content is recorded in a medium, an encryption key that depends on a storage device is not recorded in the medium. Moreover, a problem exists in that, when an encryption key is recorded in, for example, a space area in the header of a content, it is undesirable because the space area may be used in another application in the future.

Moreover, even when the aforementioned operation is implemented, using the known technique disclosed in Patent Document 3, the following problem exists. Specifically, even when a content A is recorded in a rewritable medium a, using a recording and playback device X that supports the known technique, the medium a can be used in another recording and playback device Y that does not support the known technique. Thus, the content A in the medium a can be erased and another content B can be recorded, using the recording and playback device Y. Accordingly, a problem exists in that a medium made in this manner is also recognized as the medium a, and even when a recorded content is the content B, the medium can be used in the recording and playback device X.

According to the disclosed technique, when the hash value of a content having been recorded from a storage device to an external medium matches the hash value of a content in a medium that is currently being loaded, the use of the content in the storage device can be permitted.

The disclosed technique achieves an effect such that the use of a content in a medium can be permitted only in a storage device used to record the content.

Preferred embodiments of an information processor and a content protection method will now be described in detail with reference to the attached drawings. In the information processor and the content protection method, convenience for users is improved by allowing a copied content copied from a storage device to a medium to be re-copied to the storage device and allowing the re-copied content to be copied to another medium on the condition that the number of times the content can be copied is reduced. In the specification, the information processor is a recording and playback device that can record and play back contents, and the content protection program is a program installed in the information processor.

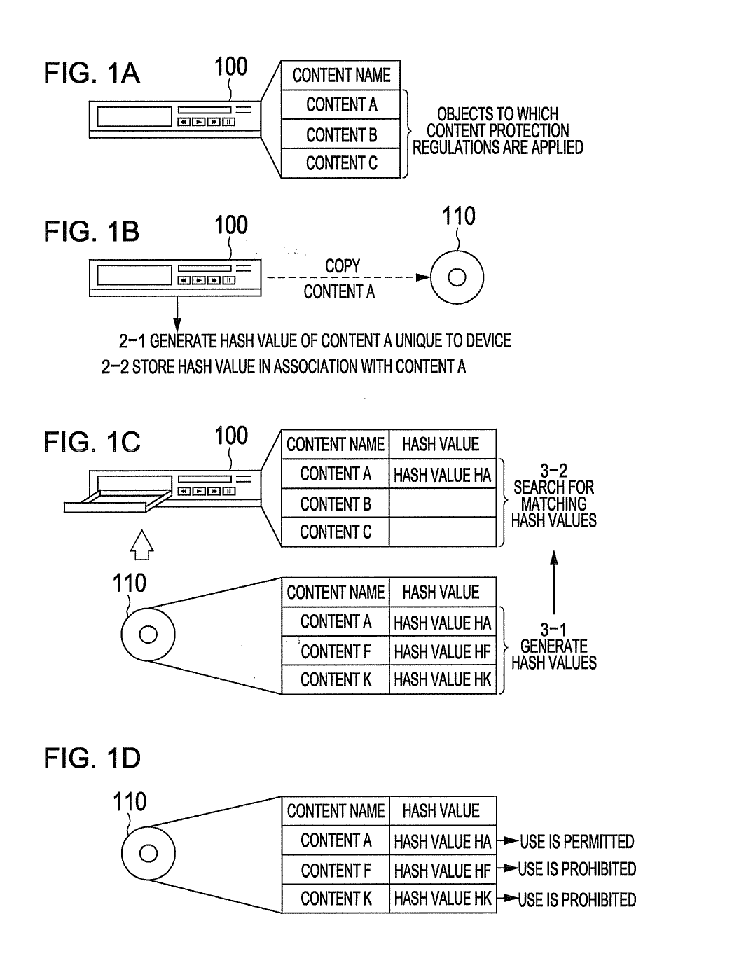

The outline of the technique will first be described. FIGS. 1A to 1D illustrate the outline of the technique. In FIG. 1A, contents A to C to which content protection regulations are applied are stored in a recording and playback device 100. Contents include, for example, video, music, images, and character strings that are expressed using digital data, and sets of information in which these items are combined. Content protection regulations include, for example, those that restrict the use of playback, movement, copying, and the like of contents. The content information includes restriction information indicative of restriction of playback, movement , copying, and the like of content.

In FIG. 1B, when the contents A to C are recorded from the recording and playback device 100 to an external medium 110, the respective hash values of the contents to be recorded unique to the recording and playback device 100 are generated and stored in association with the contents. For example, when the content A is copied to the medium 110, (2-1) the hash value of the content A unique to the recording and playback device 100 is generated and (2-2) stored in association with the content A.

In this case, the content is recorded in the medium 110, the content may be stored in the exterior of the recording and playback device 100 through a network.

In FIG. 1C, subsequently, in the recording and playback device 100, when contents A, F, and K recorded in the medium 110 are used, (3-1) respective hash values HA, HF, and HK of the contents A, F, and K in the medium 110 are first generated, and then (3-2) hash values, out of the hash values stored in the recording and playback device 100, matching the generated hash values are searched for.

In this case, the content A in the medium 110 is a content recorded in the medium 110, using the recording and playback device 110. Moreover, the content F is a content recorded in the medium 110, using another storage device. Moreover, the content K is a content recorded in the medium 110, using another recording and playback device that supports the technique.

In FIG. 1D, only when a matching hash value is found, the use (for example, playback, copying, and movement) of a content from which the hash value has been generated is permitted in the recording and playback device 100. In this case, only for the hash value HA of the content A in the medium 110, a matching hash value is found.

Thus, the use of only the content A, out of the contents A, F, and K in the medium 110, in the recording and playback device 100 is permitted. On the other hand, regarding the contents F and K, since no matching hash value is found, the use of the contents F and K in the recording and playback device 100 is prohibited. That is, in the recording and playback device 100, playback, copying, and movement of the contents F and K cannot be performed.

In this manner, according to the technique, only the use of the content A recorded using the recording and playback device 100 can be permitted. On the other hand, the use of the content F recorded in the medium 110 using the other storage device can be prohibited in the recording and playback device 100. Moreover, since the hash values subjected to search are hash values unique to the recording and playback device 100, the use of the content K recorded in the medium 110 using the other recording and playback device supporting the technique can be prohibited in the recording and playback device 100.

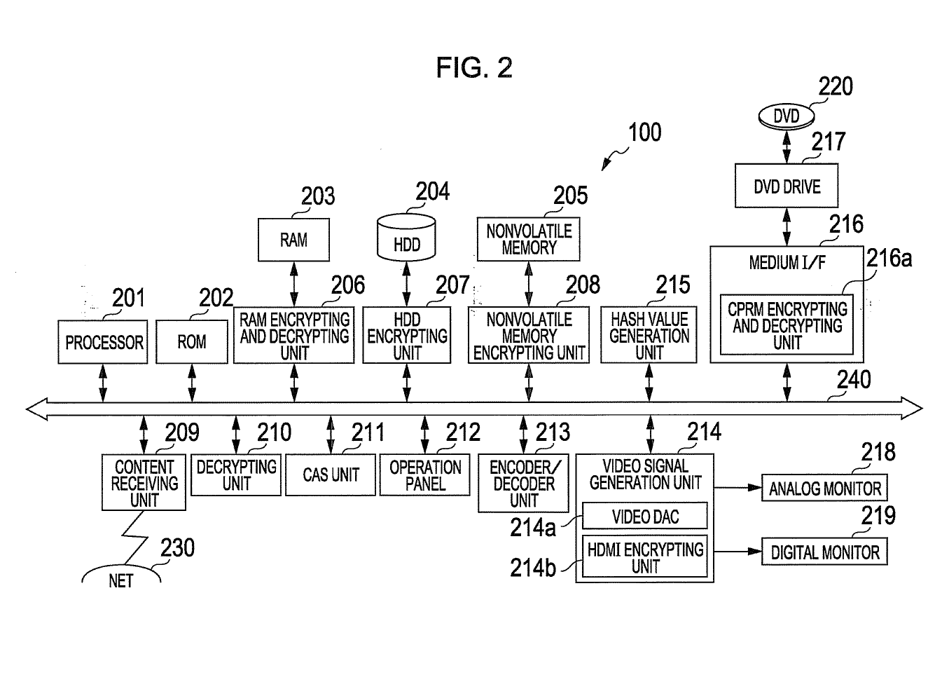

The hardware components of the recording and playback device 100 according to a first embodiment will next be described. FIG. 2 is a block diagram of exemplary hardware components of the recording and playback device according to the first embodiment. In FIG. 2, the recording and playback device 100 includes a processor 201, a Read-Only Memory (ROM) 202, a Random Access Memory (RAM) 203, a Hard Disk Drive (HDD) 204, a nonvolatile memory 205, a RAM encrypting and decrypting unit 206, an HDD encrypting unit 207, a nonvolatile memory encrypting unit 208, a content receiving unit 209, a decrypting unit 210, a Conditional Access Systems (CAS) unit 211, an operation panel 212, an encoder/decoder unit 213, a video signal generator 214, a hash value generator 215, a medium Interface (I/F) 216, and a Digital Versatile Disk (DVD) drive 217. The individual components are connected to each other via a bus 240.

The processor 201 performs overall control of the recording and playback device 100. The ROM 202 stores programs such as a boot program. The RAM 203 is used as a storage area for temporary data. Temporary data is stored after being encrypted by the RAM encrypting and decrypting unit 206. When temporary data in the RAM 203 is used, the temporary data is used after being decrypted by the RAM encrypting and decrypting unit 206.

The HDD 204 controls read/write of data on a hard disk under the control of the processor 201. Data to be stored in the HDD 204 is encrypted by the HDD encrypting unit 207. An encryption key used at this time is randomly generated by the processor 201 for each encryption operation.

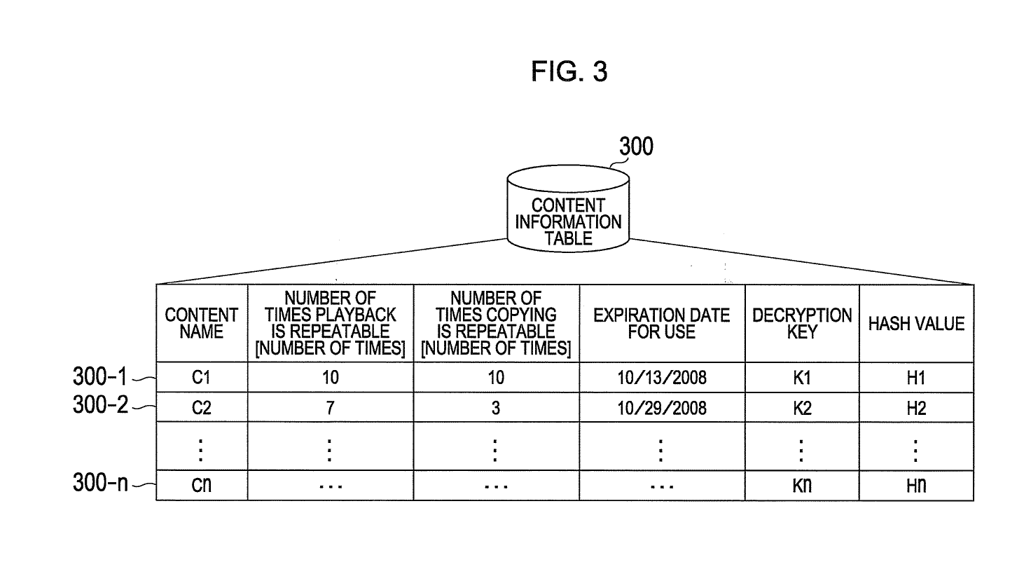

The nonvolatile memory 205 is one of storage devices. The nonvolatile memory 205 stores data that needs to be stored even when the power of the recording and playback device 100 is turned off. Moreover, an encryption key used to encrypt data to be stored in the HDD 204 is stored in the nonvolatile memory 205 after being encrypted by the nonvolatile memory encrypting unit 208 (corresponding to a “decryption key” is illustrated in FIG. 3).

The content receiving unit 209 receives contents such as video data and music data via networks 230 such as an Internet Protocol (IP) network and broadcast waves. The decrypting unit 210 decrypts encrypted data. The CAS unit 211 holds a decryption key for decrypting contents encrypted so that only a specific user can use the contents.

For example, when an encrypted content has been received by the content receiving unit 209, the decrypting unit 210 decrypts the encrypted content, using a decryption key obtained from the CAS unit 211. The content received by the content receiving unit 209 is stored in the HDD 204 after being encrypted by the HDD encrypting unit 207.

The operation panel 212 includes keys for inputting characters, numerals, various types of instructions (for example, an instruction to record a content and an instruction to play back a content), and the like, and data is input, using the operation panel 212. The operation panel 212 may be a touch panel input pad or a numeric keypad. The encoder/decoder unit 213 decodes a content decrypted by the decrypting unit 210.

The video signal generator 214 includes a Video Digital to Analog Converter (DAC) 214a and a High Definition Multimedia Interface (HDMI) encrypting unit 214b and generates video signals from contents sent from the encoder/decoder unit 213.

The Video DAC 214a converts digital video signals to analog signals and outputs the analog signals to an analog monitor 218. The HDMI encrypting unit 214b performs HDMI encryption on digital video signals and outputs the output to a digital monitor 219. The analog monitor 218 and the digital monitor 219 may be components provided in the recording and playback device 100 or may be provided in a separate body.

The hash value generator 215 generates the hash value of a content. Specifically, for example, the hash value generator 215 can generate the hash value of a content by passing the content to a hash function such as the Secure Hash Algorithm (SHA) or the Message Digest (MD).

The medium I/F 216 includes a Content Protection for Recordable Media (CPRM) encrypting and decrypting unit 216a and controls input and output of data from external media such as a magnetic disk and an optical disk (in this case, only a DVD 220 is illustrated). The CPRM encrypting and decrypting unit 216a performs CPRM encryption on a content.

The DVD drive 217 controls read/write of data on the DVD 220 under the control of the processor 201. Written data is stored in the DVD 220 under the control of the DVD drive 217, or a computer is caused to read data stored in the DVD 220.

The outline of an operation of the recording and playback device 100 for playing back a content will now be described. When a content is played back, the processor 201 first reads the content to be played back from the HDD 204. Then, the decrypting unit 210 reads an encryption key (corresponding to a “decryption key” illustrated in FIG. 3) used to encrypt the content from the nonvolatile memory 205 and decrypts the encryption key.

Then, the decrypting unit 210 decrypts the content read from the HDD 204, using the encryption key. Furthermore, the encoder/decoder unit 213 decodes the content. In this case, analog output is performed, the video signal generator 214 converts digital video signals to analog signals, using the Video DAC 214a, and outputs the analog signals to the analog monitor 218. On the other hand, digital output is performed, the video signal generator 214 performs HDMI encryption on the content, using the HDMI encrypting unit 214b, and outputs the output to the digital monitor 219.

The outline of an operation of the recording and playback device 100 for recording a content in a medium (in this case, the DVD 220) will next be described. When a content is recorded in the DVD 220, the processor 201 first reads, from the HDD 204, the content to be recorded. Then, the decrypting unit 210 reads an encryption key used to encrypt the content from the nonvolatile memory 205 and decrypts the encryption key.

Then, the decrypting unit 210 decrypts the content read from the HDD 204, using the encryption key. Subsequently, the medium I/F 216 performs CPRM encryption on the content, using the CPRM encrypting and decrypting unit 216a. Finally, the DVD drive 217 writes the content having been subjected to CPRM encryption to the DVD 220.

The description has been given, taking the DVD 220 as an example of a medium for recording. However, when a content is recorded in another medium, the content is recorded in the medium after being encrypted by an encrypting and decrypting unit (corresponding to the aforementioned CPRM encrypting and decrypting unit 216a) specific to the medium. In this case, it is assumed that dedicated hardware components such as the hash value generator 215 are provided. Alternatively, the arrangement may be implemented, using the processor 201.

The storage content of a content information table stored in the nonvolatile memory 205 illustrated in FIG. 2 will next be described. FIG. 3 is a first illustration of an example of the storage content of a content information table.

In FIG. 3, a content information table 300 includes fields such as content name, number of times playback is repeatable, number of times copying is repeatable, expiration date for use, decryption key, and hash value. Pieces of content information 300-1 to 300-n on contents, limitations on the use of the contents being set, are stored as records by setting information in the individual fields.

In this case, a content name represents a name for identifying a content. The number of times playback is repeatable represents the remaining number of times a content can be played back. The number of times copying is repeatable represents the remaining number of times a content can be copied. An expiration date for use represents an expiration date (year/month/day) until when a content can be used.

A decryption key represents an encryption key used by the HDD encrypting unit 207 to encrypt a content. A content read from the HDD 204 is decrypted, using the decryption key. A hash value represents a fixed-length bit string obtained from a content. A hash value is unique to the recording and playback device 100. A hash value in this case is that of an encrypted content having been subjected to CPRM encryption by the CPRM encrypting and decrypting unit 216a illustrated in FIG. 2.

Taking the content information 300-2 as an example, regarding a content C2, the remaining number of times playback is repeatable is “7”, the remaining number of times copying is repeatable is “3”, the expiration date for use is “Oct. 29, 2008”, the decryption key is “decryption key K2”, and the hash value is “hash value H2”. The pieces of content information 300-1 to 300-n are stored after being encrypted by the nonvolatile memory encrypting unit 208. Moreover, although not illustrated, each of the pieces of content information 300-1 to 300-n may include a medium ID for identifying a medium in which a corresponding content is recorded.

The functional components of the recording and playback device 100 according to the first embodiment will next be described. The functional components described here are those that permit the use, in the recording and playback device 100, of only contents recorded from the recording and playback device 100 to a medium when contents in the medium are used.

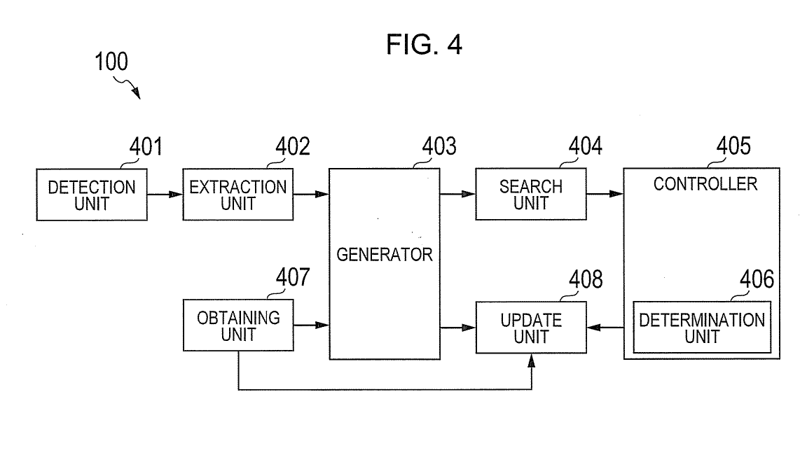

FIG. 4 is a block diagram of the functional components of the recording and playback device according to the first embodiment. In FIG. 4, the recording and playback device 100 includes a detection unit 401, an extraction unit 402, a generator 403, a search unit 404, a controller 405, a determination unit 406, an obtaining unit 407, and an update unit 408. Specifically, for example, the functions (the detection unit 401 to the update unit 408) that are the controller 405 are implemented by causing the processor 201 to execute programs stored in storage areas such as the ROM 202, the RAM 203, and the HDD 204 illustrated in FIG. 2.

The detection unit 401 has a function of detecting loading of a medium into the recording and playback device 100. In this case, media are recording media for recording data. Media include, for example, the DVD 220, a Compact Disk (CD), and a Blu ray Disk (BD).

Specifically, for example, the detection unit 401 may detect loading of a medium into the device main body by accepting a signal from a sensor (not illustrated) provided at a loading slot for media. The detection result is stored in storage areas, for example, the RAM 203 and the HDD 204.

The extraction unit 402 has a function of extracting a selected content from a medium when detecting loading of the medium. Contents to which content protection regulations are applied are recorded in each medium. Predetermined limitations on use, for example, the number of times playback is repeatable, the number of times copying is repeatable, and the number of times movement is repeatable, are set for these contents. The limitations are restriction information.

Moreover, contents are recorded in each medium in a state in which the contents are encrypted according to a system defined in content protection regulations. Encryption systems include, for example, the CPRM system that is one of the copyright protection techniques. According to this technique, the use of contents in equipment that does not support the technique can be prohibited.

Specifically, for example, the extraction unit 402 reads a selected content from the DVD 220, using the DVD drive 217 illustrated in FIG. 2. The extraction result is stored in storage areas, for example, the RAM 203 and the HDD 204. This extraction operation is repeated until, for example, contents that have not been extracted from the DVD 220 do not exist.

The generator 403 has a function of generating identification information for uniquely identifying a selected content that has been extracted (hereinafter called an “extracted content”). In this case, identification information is a hash value obtained by, for example, passing a content to a hash function. The following description will be given, assuming that identification information is a hash value obtained from each content.

The generator 403 generates unique information that is unique to combination of the content information and the information processor 100 through an operation of identification information of the content information and the information processor 100.

Specifically, for example, the generator 403 may generate the hash value of an extracted content by passing a part of or the whole of the extracted content to a hash function, using the hash value generator 215 illustrated in FIG. 2. The generation result is stored in storage areas, for example, the RAM 203 and the HDD 204.

The search unit 404 has a function of searching for the generated hash value in a table in which, for each of the contents that have been recorded from the recording and playback dice 100 to a medium, a hash value unique to the recording and playback device 100 for uniquely identifying the content is stored. The table is, for example, the content information table 300 (refer to FIG. 3) stored in the nonvolatile memory 205.

Specifically, for example, the search unit 404 searches a hash value group H1 to Hn for a hash value matching the generated hash value, referring to the pieces of content information 300-1 to 300-n. When the pieces of content information 300-1 to 300-n are referred to, the pieces of content information 300-1 to 300-n are decrypted by the nonvolatile memory encrypting unit 208. The search result is stored in storage areas, for example, the RAM 203 and the HDD 204.

The determination unit 406 has a function of determining, on the basis of the search result, whether a content in a medium can be used. Specifically, for example, when the hash value of an extracted content is found, the determination unit 406 determines that the extracted content can be used. On the other hand, when the hash value of the extracted content is not found, the determination unit 406 determines that the extracted content cannot be used.

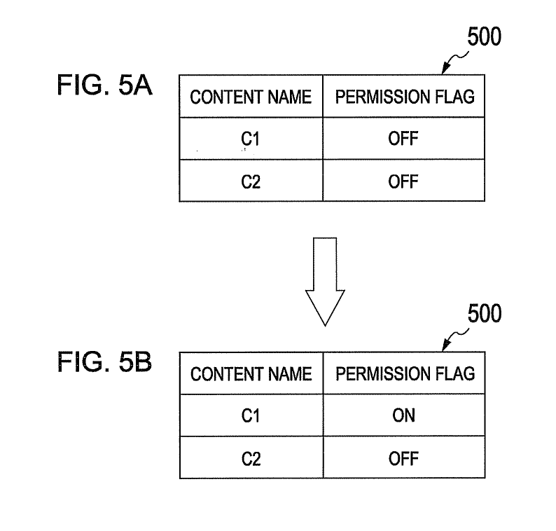

Storing the data of the result of determination made by the determination unit 406 will now be described. In this case, a determination result table is used to store data. A determination result table is stored in storage areas, for example, the RAM 203 and the HDD 204. Each of FIGS. 5A and 5B is a determination result table.

In FIG. 5A, a determination result table 500 includes a content name field and a permission flag field, and the content name of each content is written to the determination result table 500. The permission flag is permission information indicative of permission of copy. A content name represents the name of a content extracted from the DVD 220. A case where a permission flag is on represents that a corresponding content can be used. A case where a permission flag is off represents that a corresponding content cannot be used. In the initial condition, a permission flag is off.

the controller 405 receives content information including permission information indicative of permission of copy, the controller allows the content information to be stored in the storage device without confirmation of matching of the unique information, and when the controller 405 receives content information including restriction information indicative of restriction of copy, the controller checks whether the content information includes information matching with the unique information and upon confirmation of matching of both the information allows the content information to be stored in the storage device.

FIG. 5A illustrates the initial condition. Subsequently, in FIG. 5B, a determination operation by the determination unit 406 is performed. In this case, since the hash value of a content C1 is found in the hash value group H1 to Hn (refer to FIG. 3), the permission flag of the content C1 is set from off to on.

On the other hand, since the hash value of the content C2 is not found, the permission flag of the content C2 remains turned off. This represents that the content C2 in the DVD 220 was not recorded, using the recording and playback device 100, but was recorded, using another storage device.

The controller 405 has a function of controlling access to contents in a medium from the recording and playback device 100, on the basis of a determination result. Specifically, for example, the controller 405 permits the use of a content in the recording and playback device, the permission flag of the content being on, referring to the determination result table 500 illustrated in FIG. 5.

The controller 405 receives content information from the exterior and storing the content information in the nonvolatile memory 205. When the controller 405 receives content information, the controller 405 checks whether the content information includes information matching with the unique information and upon confirmation of both the information allows the content information to be stored in the nonvolatile memory 205.

In this case, since the permission flag of the content C1 is on, the use of the content C1 in the recording and playback device 100 is permitted. As a result, when an instruction to play back the content C1 or an instruction to copy the content C1 has been issued, an operation corresponding to the instruction is performed. In this case, various types of instructions are accepted through, for example, input of operations by a user using the operation panel 212 illustrated in FIG. 2.

On the other hand, since the permission flag of the content C2 is off, the use of the content C2 in the recording and playback device 100 is prohibited. As a result, even when an instruction to play back the content C2 or an instruction to copy the content C2 has been issued, an operation corresponding to the instruction is not performed. That is, the use, in the recording and playback device 100, of the content C2 recorded in the DVD 220 using another storage device can be prohibited.

Moreover, the determination unit 406 may determine, on the basis of the search result and information about the right to use a content, whether the content in a medium can be used. Specifically, for example, when the hash value of an extracted content is found and when the expiration date for use of the extracted content has not come, the determination unit 406 may determine that the extracted content can be used.

Taking the aforementioned content C1 as an example, as a result of having found the hash value of the content C1 extracted from the DVD 220, the determination unit 406 refers to the content information 300-1 and determines that the content C1 can be used when the current date is the same as or prior to the expiration date for use of the content C1, Oct. 13, 2008. In this case, for example, the current date is measured in the recording and playback device 100.

Moreover, when the hash value of an extracted content is found and when the remaining number of times the extracted content can be used restricting the use of the extracted content exists, the determination unit 406 may determine that the extracted content can be used. The number of times a content can be used restricting the use of the content includes, for example, the number of times playback is repeatable, the number of times copying is repeatable, and the number of times movement is repeatable.

Taking the aforementioned content C1 as an example, as a result of having found the hash value of the content C1 extracted from the DVD 220, the determination unit 406 refers to the content information 300-1 and determines that the content C1 can be used when the remaining number of times the content C1 can be used exists for each usage type (in this case, playback or copying).

In this case, as a result of determining that the extracted content can be used, the controller 405 may permit the use of the extracted content in the recording and playback device 100 by subtracting a predetermined number of times (for example, once) from the number of times the extracted content can be used stored in the aforementioned table (for example, the content information table 300).

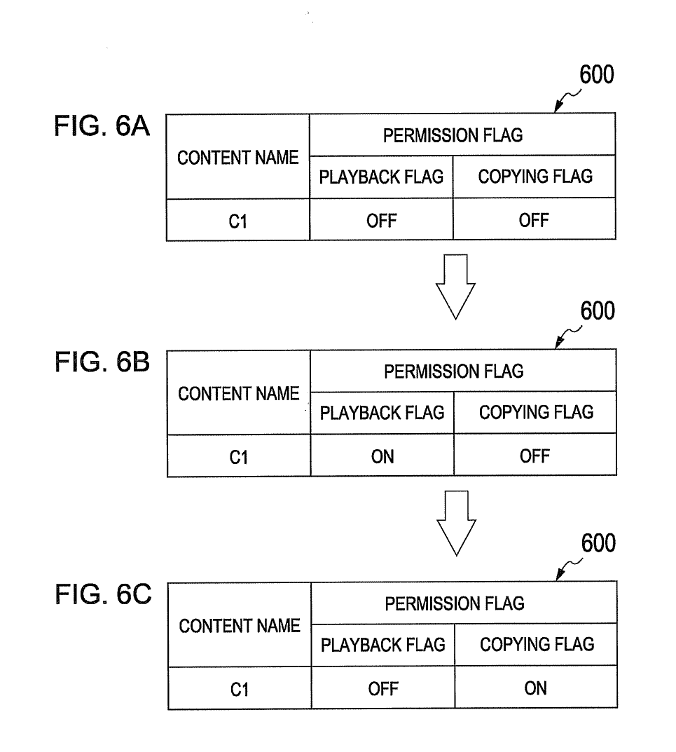

The storage content of a determination result table will now be described, taking the content C1 extracted from the DVD 220 as an example. Each of FIGS. 6A to 6C is a determination result table. In FIG. 6A, a determination result table 600 includes a content name field and permission flag fields. A playback flag and a copying flag are set in the permission flag fields.

A case where a playback flag is on represents that a corresponding content can be played back. A case where a playback flag is off represents that a corresponding content cannot be played back. A case where a copying flag is on represents that a corresponding content can be copied. A case where a copying flag is off represents that a corresponding content cannot be copied. In the initial condition, a playback flag and a copying flag are off.

FIG. 6A illustrates the initial condition. Subsequently, in FIG. 6B, a determination operation based on a search result and the number of times playback is repeatable is performed. In this case, since the hash value of the content C1 is found and the remaining number of times the content C1 can be played back is “10”, the playback flag of the content C1 is set from off to on. Furthermore, in FIG. 6C, a determination operation based on the number of times copying is repeatable is performed. In this case, since the remaining number of times the content C1 can be copied is “10”, the copying flag of the content C1 is set from off to on.

In this case, the controller 405 controls access to the content C1 in the DVD 220 from the recording and playback device 100, referring to the content information 300-1 about the content C1 and the determination result table 600. A specific exemplary control operation in a case where an instruction to play back the content C1 and an instruction to copy the content C1 have been issued from a user will now be described.

When an instruction to play back the content C1 has been issued, the controller 405 first determines whether the playback flag of the content C1 in the determination result table 600 is on. In this case, the playback flag is on, playback of the content C1 in the recording and playback device 100 is permitted, changing the number of times playback is repeatable of the content information 300-1 from 10 to 9 by the use of the update unit 408 described below.

Furthermore, when an instruction to copy the content C1 has been issued, the controller 405 determines whether the copying flag of the content C1 in the determination result table 600 is on. In this case, the copying flag is on, copying of the content C1 in the recording and playback device 100 is permitted, changing the number of times copying is repeatable of the content information 300-1 from 10 to 9 by the use of the update unit 408 described below.

Furthermore, when a content is used, to decrypt an encrypted content, it may be checked whether corresponding medium IDs match each other. Specifically, for example, when the content C1 in the DVD 220 is used, it is checked whether the medium ID ^{,}of the DVD 220 matches a medium ID (not illustrated) included in the content information 300-1.

When the medium IDs match each other, decryption of the content C1 having been subjected to CPRM encryption is permitted. On the other hand, when the medium IDs do not match each other, decryption of the content C1 is prohibited. In this arrangement, the recording and playback device 100 can be securely associated, in a one-to-one manner, with the DVD 220, to which the content C1 was copied from the recording and playback device 100.

The content information table may include the information of the determination result table. When the controller 405 receives content information including permission information indicative of permission of copy, the controller 405 allows the content information to be stored in the storage device 204 without confirmation of matching of the unique information. When the controller 405 receives content information including restriction information indicative of restriction of copy, the controller 405 checks whether the content information includes information matching with the unique information and upon confirmation of matching of both the information allows the content information to be stored in the storage device 204.

A specific exemplary method for creating a table that stores a hash value unique to the recording and playback device 100 for uniquely identifying a content will now be described. The obtaining unit 407 first obtains a content to which content protection regulation are applied. Specifically, for example, the obtaining unit 407 receives a content, using the content receiving unit 209. For example, the obtained content is stored in the HDD 204 after being encrypted by the HDD encrypting unit 207.

Subsequently, the update unit 408 creates a new record by setting information in fields included in a table related to the right to use. Specifically, for example, regarding the received content, the update unit 408 creates a new record by setting information in the fields in the content information table 300: content name, number of times playback is repeatable, number of times copying is repeatable, expiration date for use, and decryption key.

In this case, information on the content name, the number of times playback is repeatable, the number of times copying is repeatable, and the expiration date for use is describe& in, for example, the header of the received content. Moreover, the decryption key is an encryption key used in encryption by the HDD encrypting unit 207.

Furthermore, when a content is recorded from the recording and playback device 100 to a medium, the generator 403 generates the hash value of the content unique to the recording and playback device 100. In this case, each content recorded in a medium is encrypted in a manner corresponding to the medium (for example, a content recorded in the DVD 220 is subjected to CPRM encryption by the CPRM encrypting and decrypting unit 216a).

Specifically, for example, the generator 403 generates the hash value of a CPRM-encrypted content to be recorded in the DVD 220 by passing the CPRM-encrypted content to a hash function. In this case, the generator 403 generates a hash value unique to the recording and playback device 100 by, for example, adding a serial number unique to the recording and playback device 100 to the end of the generated hash value.

Then, the update unit 408 sets the generated hash value in the hash value field in a corresponding record in the table. Specifically, for example, the update unit 408 sets the generated hash value of the CPRM-encrypted content in the hash value field in a corresponding record in the content information table 300, using a content name as a key.

In this manner, every time a content to which content protection regulations are applied is recorded from the recording and playback device 100 to a medium, a new record about the content is created in the content information table 300. Every time a content to which content protection regulations are applied is used, the pieces of content information 300-1 to 300-n are referred to and updated. Moreover, when the pieces of content information 300-1 to 300-n are referred to and updated, in a case where any content that has no corresponding content information exists, the content may be deleted from the HDD 204.

The content protection procedure of the recording and playback device 100 according to the first embodiment will next be described. In this case, the description will be given, taking, as an example, a case where a determination result table (for example, the determination result table 500) is used to store the data of the result of determination made by the determination unit 406. Moreover, the description will be given, taking the DVD 220 as an exemplary unloadable medium.

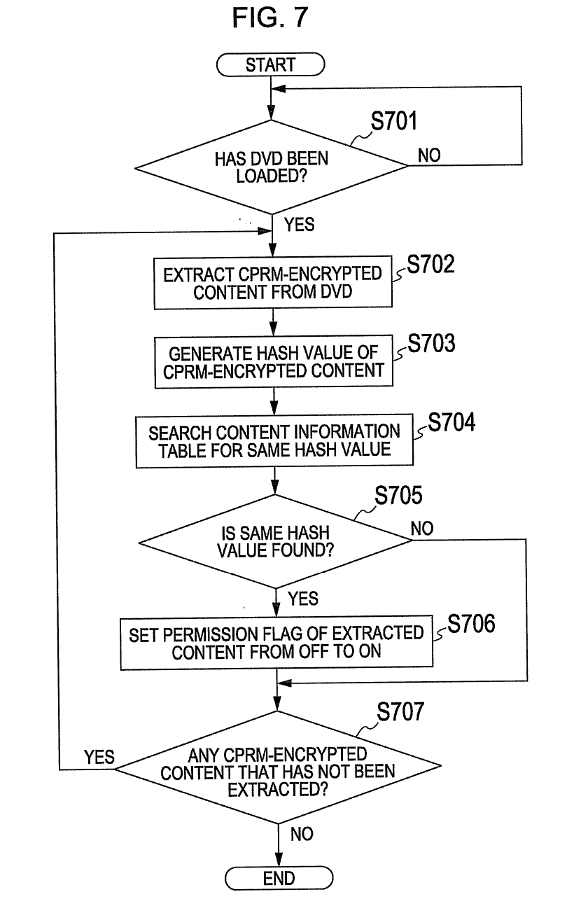

FIG. 7 is a flowchart of an example of the content protection procedure of the recording and playback device according to the first embodiment. In the flowchart in FIG. 7, the detection unit 401 first determines whether loading of the DVD 220 has been detected (step S701).

Loading of the DVD 220 is waited for (step S701: No), and when the DVD 220 has been loaded (step S701: Yes), the extraction unit 402 extracts a selected CPRM-encrypted content from the DVD 220 (step S702). Then, the generator 403 generates the hash value of the extracted CPRM-encrypted content (hereinafter called an extracted content) (step S703).

Subsequently, the search unit 404 searches the content information table 300 for the same hash value as the generated hash value (step S704), and it is determined whether the same hash value is found (step S705). When the same hash value is found (step S705: Yes), the determination unit 406 determines that the extracted content can be used and sets the permission flag of the extracted content in the determination result table from off to on (step S706).

Then, it is determined whether any CPRM-encrypted content that has not been extracted from the DVD 220 by the extraction unit 402 exists (step S707). When any CPRM-encrypted content that has not been extracted exists (step S707: Yes), the process returns to step S702.

On the other hand, no CPRM-encrypted content that has not been extracted exists (step S707: No), a series of steps according to the flowchart is completed. Moreover, when the same hash value is not found in step S705 (step S705: No), the process proceeds to step S707.

According to the first embodiment described above, when the hash value of a content that has been recorded from the recording and playback device 100 to a medium matches the hash value of a content in a medium that is currently being loaded, the use of the content can be permitted. In this arrangement, the use, in the recording and playback device 100, of only contents recorded from the recording and playback device 100 to a medium can be permitted.

Moreover, falsification of the pieces of content information 300-1 to 300-n on limitations on the use of contents can be prevented by storing the pieces of content information 300-1 to 300-n in the nonvolatile memory 205 difficult to be read from the outside. Moreover, when an encrypted content in a medium is used after being decrypted, the recording and playback device 100 can be securely associated, in a one-to-one manner, with a medium to which a content was recorded from the recording and playback device 100 by checking whether corresponding medium IDs match each other.

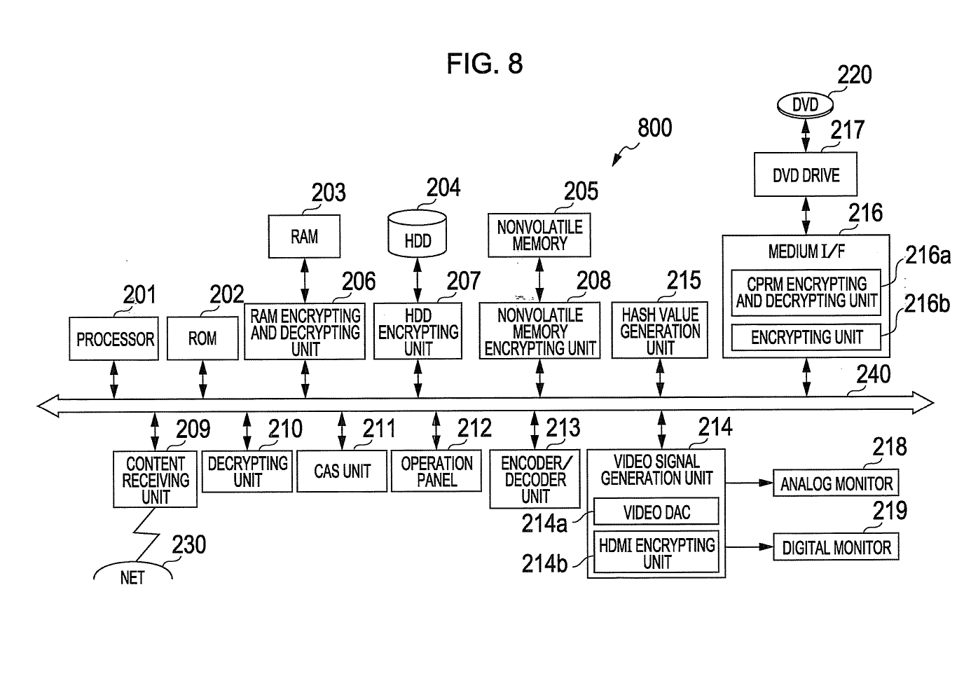

A recording and playback device 800 (refer to FIG. 8) according to a second embodiment will now be described. In the first embodiment, it is determined that a content (a CPRM-encrypted content) in the DVD 220 was recorded by the use of the recording and playback device 100 by checking that a hash value obtained from the content matches a hash value stored in the content information table 300.

A highly one-way hash value is used as a hash value used in this matching check. That is, a hash value such that it is difficult to find data corresponding to the hash value, the hash value is highly collision-resistant, and the probability that a hash value obtained from different data is the same as the hash value is sufficiently low is used.

However, a content from which the same hash value can be obtained may be generated in a relatively short time accidentally or by the improvement of computing power or discovering the vulnerability. Thus, in the second embodiment, a method for improving the security by performing matching check for a hash value obtained from a content twice is proposed.

Specifically, for example, matching check for a hash value obtained from a CPRM-encrypted content extracted from the DVD 220 is first performed (the first time matching check). This arrangement is the same as that in the first embodiment. In this case, when matching is confirmed, the CPRM-encrypted content is decrypted.

Then, matching check for a hash value obtained from the decrypted content is performed (the second matching check). In this arrangement, an operation of permitting the use, in the recording and playback device 100, of only contents recorded from the recording and playback device 100 to a medium is implemented, and the security is improved. In the following section, the same reference numerals as in the first embodiment are assigned to the same parts as those described in the first embodiment, and the description is omitted.

The hardware components of the recording and playback device 800 according to the second embodiment will first be described. FIG. 8 is a block diagram of exemplary hardware components of the recording and playback device according to the second embodiment. In FIG. 8, the recording and playback device 800 includes the processor 201 to the DVD drive 217.

The medium I/F 216 includes the CPRM encrypting and decrypting unit 216a and an encrypting unit 216b. The encrypting unit 216b encrypts a content decrypted by the CPRM encrypting and decrypting unit 216a. A content subjected to decryption by the CPRM encrypting and decrypting unit 216a is a CPRM-encrypted content read from the DVD 220.

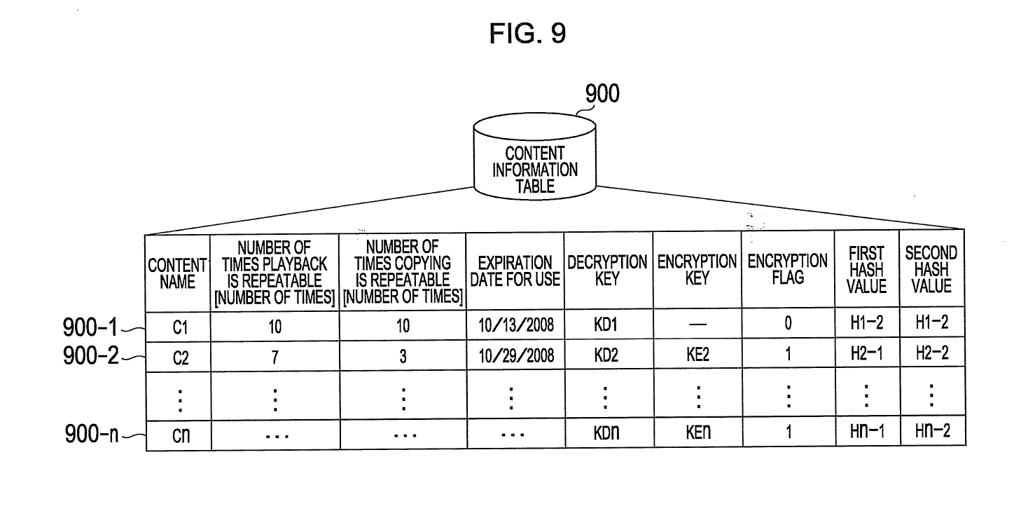

An encryption key used in encryption by the encrypting unit 216b is generated by the processor 201 to be stored in a content information table 900 described below in FIG. 9. Furthermore, an encrypted content encrypted by the encrypting unit 216b is stored in the HDD 204. At this time, encryption by the HDD encrypting unit 207 is not performed.

Encryption by the encrypting unit 216b will now be described. When a large buffer area is necessary to generate the hash value of a content, a buffer area in the hash value generator 215 may be insufficient. In this case, data the hash value of which is to be generated needs to be temporarily stored in storage areas such as the RAM 203 and the HDD 204.

For example, in the second matching check described above, when the hash value of a content decrypted by the CPRM encrypting and decrypting unit 216a is generated, the content is temporarily stored in storage areas such as the RAM 203 and the HDD 204. However, in the second matching check, a content the hash value of which is to be generated is a decrypted content, i.e., a plaintext.

When the hash value of a content that is a plaintext is generated, transferring the content to the RAM 203, the HDD 204, and the like frequently or for a long time is not preferable in terms of the security even on a route for which illegal activities such as stealing and falsification are considered. Thus, in view of the security, an arrangement in which data the hash value of which is to be generated can be transferred to storage areas such as the HDD 204 after being encrypted by the encrypting unit 216b is adopted.

The storage content of a content information table stored in the nonvolatile memory 205 in the recording and playback device 800 will next be described. FIG. 9 is a second illustration of an example of the storage content of a content information table.

In FIG. 9, the content information table 900 includes fields such as content name, number of times playback is repeatable, number of times copying is repeatable, expiration date for use, decryption key, encryption key, encryption flag, first hash value, and second hash value. Pieces of content information 900-1 to 900-n on contents, limitations on the use of the contents being set, are stored as records by setting information in the individual fields.

In this case, a decryption key represents an encryption key used by the HDD encrypting unit 207 to encrypt a content. An encryption key represents an encryption key used by the encrypting unit 216b to encrypt a content. An encryption flag represents a flag for identifying whether an object the hash value of which is to be generated has been encrypted by the encrypting unit 216b. A case where an encryption flag is “0” represents that encryption has not been performed. A case where an encryption flag is “1” represents that encryption has been performed. In the initial condition, an encryption flag is “0”.

A first hash value represents a hash value to be used in the second matching check. A first hash value is, for example, the hash value of a content (a plaintext) that has not been subjected to encryption performed by the CPRM encrypting and decrypting unit 216a at the time of recording the content in the DVD 220. A second hash value represents a hash value to be used in the first matching check. A second hash value is, for example, the hash value of an encrypted content encrypted by the CPRM encrypting and decrypting unit 216a.

Taking the content information 900-2 as an example, regarding a content C2, the remaining number of times playback is repeatable is “7”, the remaining number of times copying is repeatable is “3”, the expiration date for use is “Oct. 29, 2008”, the decryption key is “key KD2”, the encryption key is “key KE2”, the first hash value is “hash value H2-1”, and the second hash value is “hash value H2-2”.

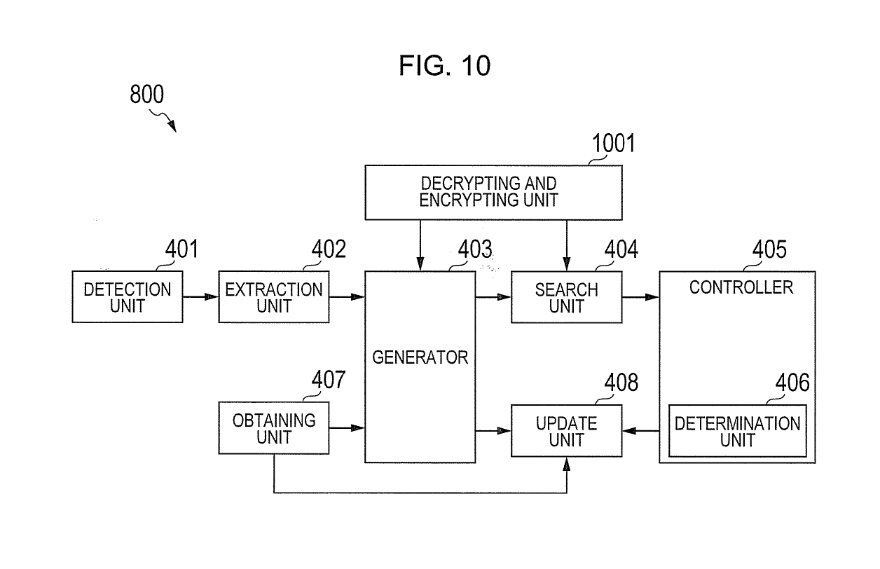

The functional components of the recording and playback device 800 according to the second embodiment will next be described. FIG. 10 is a block diagram of the functional components of the recording and playback device according to the second embodiment. In FIG. 10, the recording and playback device 800 includes the detection unit 401 to the update unit 408 and a decrypting and encrypting unit 1001. Specifically, for example, the functions (the detection unit 401 to the update unit 408 and the decrypting and encrypting unit 1001) that are the controller 405 are implemented by causing the processor 201 to execute programs stored in storage areas such as the ROM 202, the RAM 203, and the HDD 204 illustrated in FIG. 8.

The extraction unit 402 first extracts a selected encrypted content from a medium. Specifically, for example, the extraction unit 402 extracts a selected CPRM-encrypted content from the DVD 220. The generator 403 generates the hash value of the extracted encrypted content. Specifically, for example, the generator 403 generates the hash value of the extracted CPRM-encrypted content by passing the CPRM-encrypted content to a hash function.

The search unit 404 searches a table (for example, the content information table 900) for the generated hash value of the encrypted content. Specifically, the search unit 404 searches a second hash value group H1-2 to Hn-2 for a hash value matching the generated hash value, referring to the pieces of content information 900-1 to 900-n.

The decrypting and encrypting unit 1001 has a function of decrypting the encrypted content when the hash value of the encrypted content is found. Specifically, for example, the decrypting and encrypting unit 1001 decrypts the CPRM-encrypted content extracted from the DVD 220, using the CPRM encrypting and decrypting unit 216a.

Furthermore, the generator 403 generates the hash value of the encrypted content, which has been decrypted (hereinafter called a “decrypted content”). Specifically, for example, the generator 403 generates the hash value of the CPRM-decrypted content by passing the CPRM-decrypted content to a hash function.

Then, the search unit 404 searches the table for the generated hash value of the decrypted content. Specifically, the search unit 404 searches a first hash value group H1-1 to Hn-1 for a hash value matching the generated hash value of the CPRM-decrypted content, referring to the pieces of content information 900-1 to 900-n.

When the hash value of the decrypted content is found, the determination unit 406 determines that the selected encrypted content can be used. Specifically, for example, when the hash value of the CPRM-decrypted content is found, the determination unit 406 determines that the content can be used. On the other hand, when the hash value of the CPRM-decrypted content is not found, the determination unit 406 determines that the content cannot be used. In this case, for example, the determination result table described in the first embodiment is used to store the data of the result of determination.

Moreover, as described above, when a large buffer area is necessary to generate a hash value, in view of the security, a content the hash value of which is to be generated is encrypted. Specifically, the decrypting and encrypting unit 1001 has a function of encrypting a decrypted content, referring to a corresponding encryption flag stored in the table.

Specifically, for example, the decrypting and encrypting unit 1001 first refers to the pieces of content information 900-1 to 900-n, using the content name of a decrypted content as a key, and determines whether the encryption flag of the decrypted content is “1”. When the encryption flag is “1”, the decrypting and encrypting unit 1001 encrypts the decrypted content, using the encrypting unit 216b.

An encryption key to be used at this time is an encryption key stored in the content information table 900. That is, the encryption key of the decrypted content is read from the content information table 900, using the content name of the decrypted content as a key, and the decrypted content is encrypted, using the encryption key.

In this case, the generator 403 generates the hash value of the encrypted content encrypted by the decrypting and encrypting unit 1001. The security when a hash value is generated can be improved by adopting an arrangement in which data the hash value of which is to be generated can be transferred to storage areas such as the HDD 204 after being encrypted in this manner.

A specific exemplary method for creating the content information table 900 will now be described. In this case, the description of the same parts (the description of a process up to creation of a new record in the content information table 900) as those in the method for creating a table described in the first embodiment is omitted.

When a content is recorded from the recording and playback device 800 to the DVD 220, the generator 403 generates the hash value, unique to the recording and playback device 800, of the content, which has not been encrypted by the CPRM encrypting and decrypting unit 216a. Specifically, for example, the generator 403 generates the hash value of the content to be recorded, using the hash value generator 215.

The update unit 408 sets the generated hash value in the first hash value field in a corresponding record in the content information table 900. Specifically, for example, the update unit 408 determines a corresponding record in the content information table 900, using the name of the content to be recorded as a key, and sets the generated hash value in the first hash value field.

Furthermore, the generator 403 generates the hash value, unique to the recording and playback device 800, of the CPRM-encrypted content encrypted by the CPRM encrypting and decrypting unit 216a. Specifically, for example, the generator 403 generates the hash value of the CPRM-encrypted content to be recorded, using the hash value generator 215.

Then, the update unit 408 sets the generated hash value in the second hash value field in a corresponding record in the content information table 900. Specifically, for example, the update unit 408 determines a corresponding record in the content information table 900, using the name of the content to be recorded as a key, and sets the generated hash value in the second hash value field.

Moreover, in view of the security when a hash value is generated, when the amount of data of a content the first hash value of which is to be generated exceeds a predetermined threshold value, a hash value is generated after the content is encrypted. In this case, for example, the predetermined threshold value is appropriately set in advance and stored in a storage area such as the ROM 202.

Specifically, for example, the encoder/decoder unit 213 first encodes a content to be recorded, the content having been decrypted by the decrypting unit 210. Then, the value of a copy control signal for the content is overwritten with a value (for example, Copy-never) for recording a content in the DVD 220.

Subsequently, the HDD encrypting unit 207 encrypts the content. The encrypted content is stored in the HDD 204 as temporary data. Then, the hash value generator 215 generates the hash value of the encrypted content stored in the HDD 204 as temporary data.

Then, a corresponding record in the content information table 900 is determined, using the name of the content to be recorded as a key, the generated hash value is set in the first hash value field, and the temporary data stored in the HDD 204 is erased. Furthermore, “1” is set in the encryption flag field of the corresponding record in the content information table 900.

In this arrangement, every time a content to which content protection regulations are applied is recorded from the recording and playback device 800 to a medium, a new record about the content is created in the content information table 900.

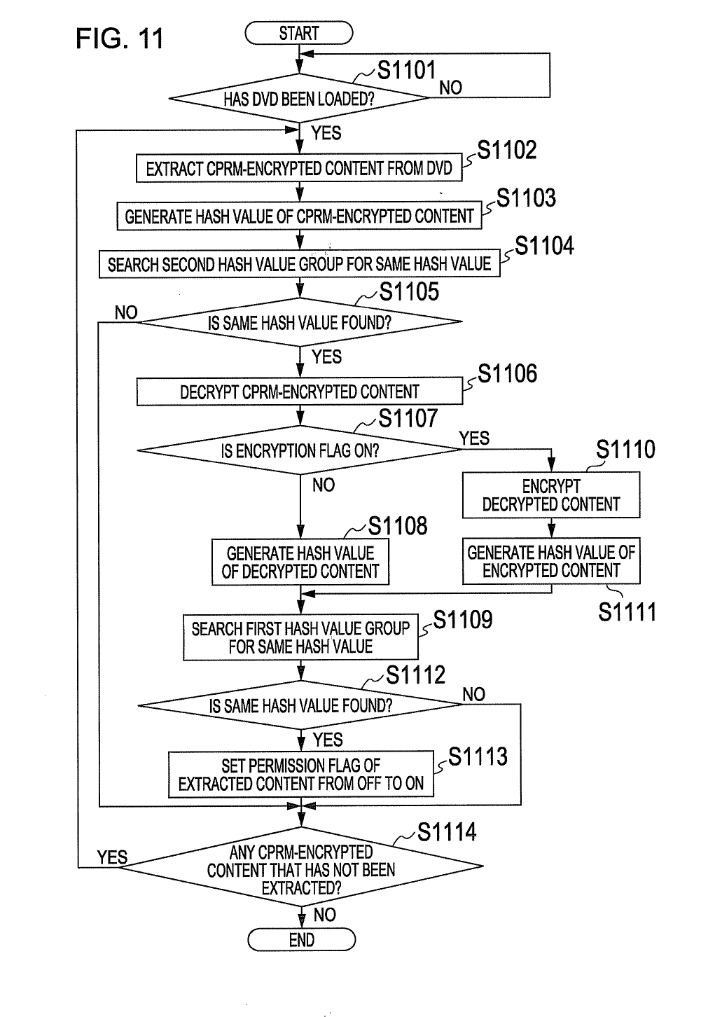

The content protection procedure of the recording and playback device 800 according to the second embodiment will next be described. In this case, the description will be given, taking, as an example, a case where a determination result table is used to store the data of the result of determination made by the determination unit 406. FIG. 11 is a flowchart of an example of the content protection procedure of the recording and playback device according to the second embodiment. In the flowchart in FIG. 11, the detection unit 401 first determines whether loading of the DVD 220 has been detected (step S1101).

Loading of the DVD 220 is waited for (step S1101: No), and when the DVD 220 has been loaded (step S1101: Yes), the extraction unit 402 extracts a selected CPRM-encrypted content from the DVD 220 (step S1102). Then, the generator 403 generates the hash value of the extracted CPRM-encrypted content (step S1103).

Subsequently, the search unit 404 searches the second hash value group H1-2 to Hn-2 in the content information table 900 for the same hash value as the generated hash value (step S1104), and it is determined whether the same hash value is found (step S1105).

When the same hash value is found (step S1105: Yes), the decrypting and encrypting unit 1001 decrypts the extracted CPRM-encrypted content (step S1106). Then, it is determined, referring to the pieces of content information 900-1 to 900-n, whether the encryption flag of the CPRM-encrypted content, which has been decrypted (hereinafter called a “decrypted content”), is on (step S1107).

When the encryption flag of the decrypted content is off (step S1107: No), the generator 403 generates the hash value of the decrypted content (step S1108). Subsequently, the search unit 404 searches the first hash value group H1-1 to Hn-1 in the content information table 900 for the same hash value as the generated hash value (step S1109).

When the encryption flag of the decrypted content is on in step S1107 (step S1107: Yes), the decrypting and encrypting unit 1001 encrypts the decrypted content, using an encryption key in a corresponding record in the content information table 900 (step S1110). In this case, the corresponding record is determined, using the content name of the decrypted content as a key.

Then, the generator 403 generates the hash value of the decrypted content, which has been encrypted (hereinafter called an “encrypted content”) (step S1111). Then, the search unit 404 searches the first hash value group H1-1 to Hn-1 in the content information table 900 for the same hash value as the generated hash value (step S1109).

Subsequently, it is determined whether the same hash value is found in the first hash value group H1-1 to Hn-1 (step S1112). When the same hash value is found (step S1112: Yes), the determination unit 406 determines that the extracted CPRM-encrypted content (hereinafter called an “extracted content”) can be used and sets the permission flag of the extracted content in the determination result table from off to on (step S1113).

Then, it is determined whether any CPRM-encrypted content that has not been extracted from the DVD 220 by the extraction unit 402 exists (step S1114). When any CPRM-encrypted content that has not been extracted exists (step S1114: Yes), the process returns to step S1102.

On the other hand, no CPRM-encrypted content that has not been extracted exists (step S1114: No), a series of steps according to the flowchart is completed. Moreover, when the same hash value is not found in step S1105 (step S1105: No), the process proceeds to step S1114. Similarly, when the same hash value is not found in step S1112 (step S1112: No), the process proceeds to step S1114.

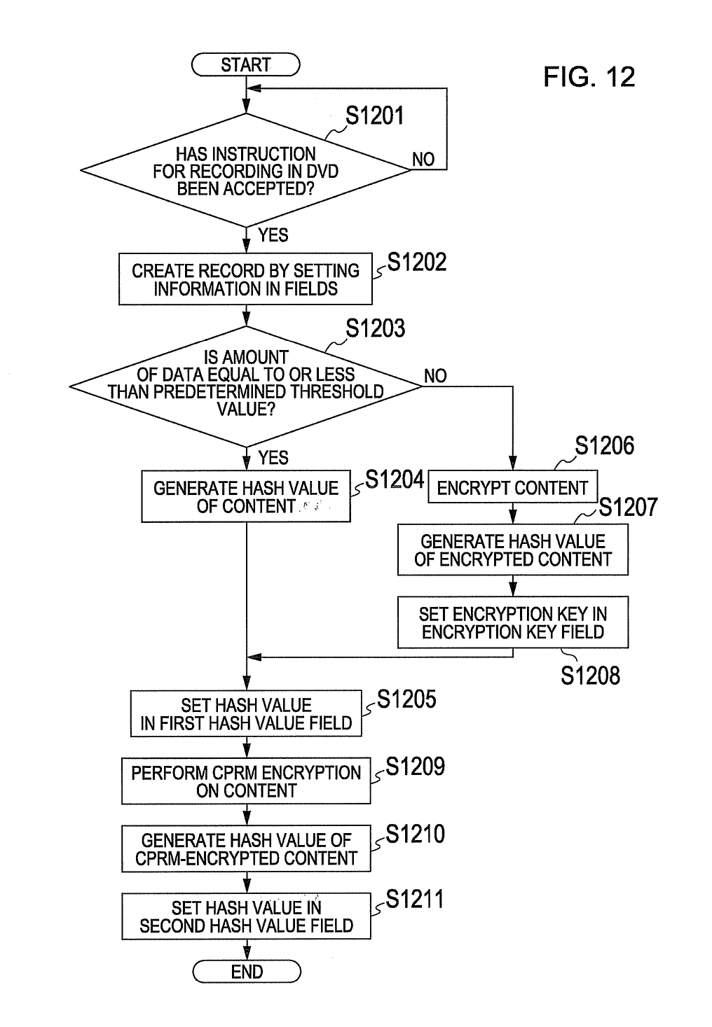

The procedure for creating the content information table 900 will next be described. FIG. 12 is a flowchart of an example of the procedure for creating the content information table. In the flowchart in FIG. 12, it is first determined whether an instruction to record a content in the DVD 220 has been accepted (step S1201).

An instruction to record a content is waited for (step S1201: No), and when an instruction to record a content has been accepted (step S1201: Yes), a record about the content to be recorded is created by setting information in the fields in the content information table 900: content name, number of times playback is repeatable, number of times copying is repeatable, and expiration date for use (step S1202).

Subsequently, it is determined whether the amount of data of the content to be recorded is equal to or less than a predetermined threshold value set in advance (step S1203). When the amount of data is equal to or less than the threshold value (step S1203: Yes), the hash value of the content unique to the recording and playback device 800 is generated (step S1204), and the generated hash value is set in the first hash value field in the corresponding record (step S1205).

When the amount of data is not equal to or less than the threshold value in step S1203 (step S1203: No), the HDD encrypting unit 207 encrypts the content to be recorded, using an encryption key generated by the processor 201 (step S1206). Then, the hash value of the encrypted content unique to the recording and playback device 800 is generated (step S1207).

Then, the encryption key used in encryption in step S1206 is set in the encryption key field in the corresponding record (step S1208). Furthermore, the hash value generated in step S1207 is set in the first hash value field in the corresponding record (step S1205).

Subsequently, the CPRM encrypting and decrypting unit 216a performs CPRM encryption on the content to be recorded (step S1209). Then, the hash value of the CPRM-encrypted content having been subjected to CPRM encryption is generated (step S1210). Finally, the generated hash value is set in the second hash value field in the corresponding record (step S1211).

According to the second embodiment described above, matching check for a hash value for determining that a content is that recorded from the recording and playback device 800 to a medium is performed twice, so that accidental or illegal generation of the same hash value can be avoided. Thus, the security can be improved.

Moreover, in the second matching check, when a large buffer area is necessary to generate the hash value of a content, the content can be transferred to storage areas such as the RAM 203 and the HDD 204 after being encrypted. Thus, since illegal activities such as stealing and falsification when a hash value is generated can be prevented, the security can be improved.

An example of the aforementioned embodiments will next be described. In the example, an exemplary operation in the management of copyrights on contents, using the present technique, will be described. In this case, an exemplary operation in which the content C1, to which content protection regulations are applied, is recorded in an external medium, using the recording and playback device 100 described in the first embodiment, will be described. In this case, the same reference numerals as in the first and second embodiments are assigned to the same parts as those described in the first and second embodiment, and the description is omitted.

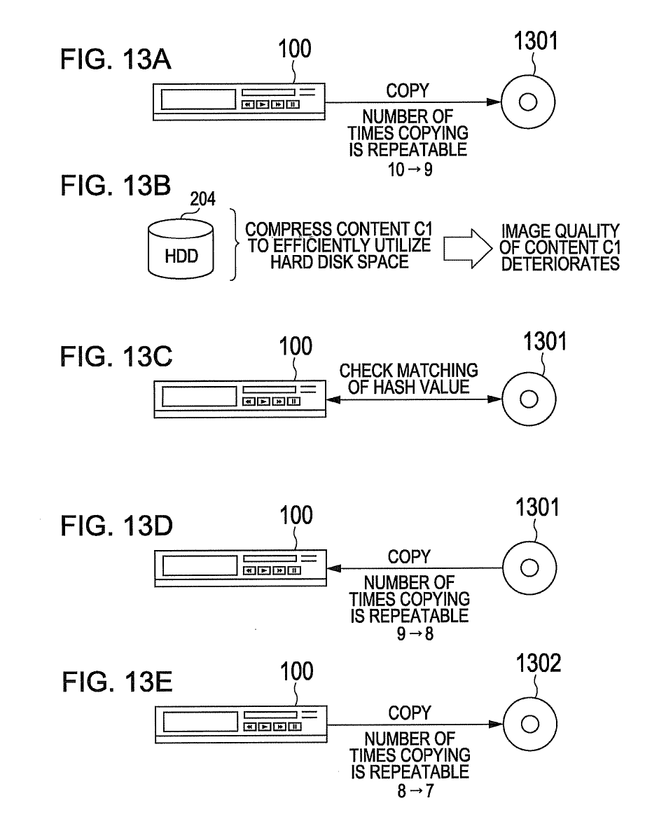

Each of FIGS. 13A to 13E is an exemplary operation in the management of copyrights on contents. In FIG. 13A, the content C1 is first copied from the recording and playback device 100 to a DVD 1301. In this case, the number of times copying is repeatable in the content information 300-1 stored in the content information table 300 is updated from ten times to nine times.

In FIG. 13B, subsequently, to efficiently utilize the hard click space in the recording and playback device 100, the content C1 to be backed up is compressed to be stored in the HDD 204. In this case, the image quality of the content C1 stored in the HDD 204 deteriorates due to data compression.

A case where the content C1 is copied from the recording and playback device 100 to a DVD 1302 other than the DVD 1301 will be considered here. Normally, in this case, the content C1, the image quality of which has deteriorated due to data compression, is copied to the DVD 1302. However, it is preferable to copy, to the DVD 1302, the content C1 with high image quality, instead of the content C1 with deteriorated image quality.

In FIG. 13C, the DVD 1301, to which the content C1 was copied in FIG. 13A, is loaded into the recording and playback device 100, and it is checked whether the hash value of the content C1 in the DVD 1301 matches a hash value group in the content information table 300. In this case, a hash value matching the hash value of the content C1 in the DVD 1301 is found, and thus the use in the recording and playback device 100 is permitted.

In FIG. 13D, subsequently, the content C1 copied from the recording and playback device 100 to the DVD 1301 is re-copied to the recording and playback device 100 on the condition that the number of times the content C1 can be copied is reduced. In this case, the content C1 in the DVD 1301 is copied to the recording and playback device 100, and the number of times copying is repeatable in the content information 300-1 is updated from nine times to eight times.

In FIG. 13E, finally, the content C1 re-copied in FIG. 13D is copied from the recording and playback device 100 to the DVD 1302. In this case, the number of times copying is repeatable in the content information 300-1 stored in the content information table 300 is updated from eight times to seven times.

In the example, the content C1 copied from the recording and playback device 100 to the DVD 1301 can be re-copied to the recording and playback device 100 on the condition that the number of times the content C1 can be copied is reduced. In this arrangement, the content C1 (a re-copied content) with high image quality can be copied to another medium (for example, the DVD 1302), and convenience for users can be improved.

That is, in the exemplary operation, for example, even in the case of a content that is prohibited to be copied to another medium, while considering convenience for users, the rights of copyright holders can be appropriately protected by permitting only copying (re-copying) in the recording and playback device 100 having been used to copy the content.

The content protection method described in the embodiments can be implemented by executing programs prepared in advance on a computer such as a personal computer or a workstation. The programs are recorded in computer-readable recording media such as a hard disk, a flexible disk, a CD-ROM, an MO, and a DVD and are executed by being read from the recording media by a computer. Moreover, the programs may be distributable via a network such as the Internet.

What is claimed is:

1. An information processor for controlling a storage device for storing content information, comprising:
a controller for receiving content information from the exterior and storing the content information in the storage device; and
a generator for generating unique information that is unique to combination of the content information and the information processor through an operation of identification information of the content information and the information processor;
wherein when the controller receives content information, the controller checks whether the content information includes information matching with the unique information and upon confirmation of both the information allows the content information to be stored in the storage device.

2. The information processor of claim 1, wherein when the controller receives content information including permission information indicative of permission of copy, the controller allows the content information to be stored in the storage device without confirmation of matching of the unique information, and when the controller receives content information including restriction information indicative of restriction of copy, the controller checks whether the content information includes information matching with the unique information and upon confirmation of matching of both the information allows the content information to be stored in the storage device.

3. The information processor of claim 1, wherein the controller stores the unique information in a nonvolatile memory.

4. A method for controlling, an information processor for storing content information in a storage device, comprising the step of:
receiving content information from the exterior;
generating unique information that is unique to combination of the content information and the information processor through an operation of identification information of the content information and the information processor; and
checking whether the content information includes information matching with the unique information and upon confirmation of both the information so as to allow the content information to be stored in the storage device after receiving the content information.

5. The method of claim 4, further comprising the steps of:
allowing the content information to be stored in the storage device without confirmation of matching of the unique information after receiving content information including permission information indicative of permission of copy; and
checking whether the content information includes information matching with the unique information and upon confirmation of matching of both the information allows the content information to be stored in the storage device after receiving content information including restriction information indicative of restriction of copy.

6. The method of claim 4, further comprising the step of storing the unique information in a nonvolatile memory.

7. A computer-readable storage medium storing a computer program of controlling an information processor for storing content information in a storage device, the computer program comprising the step of:
receiving content information from the exterior;
generating unique information that is unique to combination of the content information and the information processor through an operation of identification information of the content information and the information processor; and
checking whether the content information includes information matching with the unique information and upon confirmation of both the information so as to allow the content information to be stored in the storage device after receiving the content information.

8. The computer-readable storage medium of claim 7, the computer program further comprising the steps of:
allowing the content information to be stored in the storage device without confirmation of matching of the unique information after receiving content information including permission information indicative of permission of copy; and
checking whether the content information includes information matching with the unique information and upon confirmation of matching of both the information allows the content information to be stored in the storage device after receiving content information including restriction information indicative of restriction of copy,.

9. The computer-readable storage medium of claim 7, the computer program further comprising the steps of storing the unique information in a nonvolatile memory.
